(19) United States
(12) Patent Application Publication
(10) Pub. No.: US 2024/0053722 A1
(43) Pub. Date: Feb. 15, 2024

(54) OBSERVATION DEVICE AND OBSERVATION METHOD

(71) Applicant: FANUC CORPORATION, Yamanashi (JP)

(72) Inventor: Sichen LIU, Yamanashi-ken (JP)

(21) Appl. No.: 18/260,138

(22) PCT Filed: Jan. 5, 2022
(86) PCT No.: PCT/JP2022/000061

§ 371 Date: Jun. 30, 2023

(30) Foreign Application Priority Data
Jan. 7, 2021 (JP) 2021-001385

(51) Int. Cl. G05B 19/402; G01M 1/16; B23Q 17/22

(52) U.S. Cl. CPC G05B 19/402; G01M 1/16; B23Q 17/22; G05B 2219/39101

(57) ABSTRACT

This observation device includes a command output unit that rotates a rotation part and stops a moving body; a first acquisition unit that acquires the rotation angle of the rotation part; a second acquisition unit that acquires the positional deviation of the moving body; a correction unit that corrects the rotation angle on the basis of an angle difference; a second storage control unit that establishes a correspondence between the rotation angle and the positional deviation; and a display control unit that displays, on a display unit, a graph indicating the correspondence between the rotation angle and the positional deviation.

### TECHNICAL FIELD

The present invention relates to an observation device and an observation method configured to observe a state of balance of a rotating body of a machine tool.

### BACKGROUND ART

In JP H03-251066 A, a field balancer is disclosed. The field balancer is a device for observing a state of balance (balance state) in rotation of a rotationally driven observation target. The observation target, for example, is a motor (a motor shaft).

### SUMMARY OF THE INVENTION

A machine tool is equipped with a rotating body that is rotationally driven. The rotating body, for example, is a spindle (main shaft) or a face plate. An operator of the machine tool installs the field balancer on the machine tool in order to measure a balance state of the rotating body. Based on the balance state of the rotating body that has been measured, the operator can perform an operation in order to correct the balance state of the rotating body.

However, the accuracy in observing the balance state of the rotating body by a field balancer depends on the manner in which the field balancer is installed, and the position where the field balancer is installed. Accordingly, it is difficult for anyone to investigate the balance state of a rotating body with stable and consistent accuracy. Further, it is also difficult for anyone to execute a balance correcting operation with stable and consistent accuracy.

The present invention has the object of solving the aforementioned problems.

According to a first aspect of the present invention, there is provided an observation device configured to observe a balance state of a rotating body of a machine tool, the machine tool including the rotating body, a detector configured to detect an angle of rotation of the rotating body, and a moving body configured to move along a movement axis perpendicular to a central line of rotation of the rotating body, the observation device including: a command output unit configured to issue a command to the machine tool so as to stop the moving body at a predetermined position while the rotating body is made to rotate; a first acquisition unit configured to acquire the angle of rotation, based on a detection signal of the detector; a first storage control unit configured to cause a storage unit to store an angular difference, in a direction of rotation of the rotating body, between an installation position that is predetermined as a position at which the detector is to be installed and an installation position at which the detector is actually installed; a second acquisition unit configured to acquire a positional deviation of the moving body in a direction of the movement axis; a compensation unit configured to compensate the angle of rotation based on the angular difference, the angle of rotation comprising a plurality of angles of rotation; a second storage control unit configured to cause the storage unit to store the plurality of angles of rotation after compensation as a plurality of compensated angles of rotation, and the positional deviation as positional deviations respectively corresponding to the plurality of compensated angles of rotation, in association with each other; and a display control unit configured to cause a display unit to display a graph showing a corresponding relationship between the plurality of compensated angles of rotation and the positional deviations that are stored in association with the plurality of compensated angles of rotation.

According to a second aspect of the present invention, there is provided an observation method for observing a balance state of a rotating body of a machine tool, the machine tool including the rotating body, a detector configured to detect an angle of rotation of the rotating body, and a moving body configured to move along a movement axis perpendicular to a central line of rotation of the rotating body, the observation method including: a command output step of issuing a command to the machine tool so as to stop the moving body at a predetermined position while the rotating body is made to rotate; a first acquisition step of acquiring the angle of rotation, based on a detection signal of the detector; a first storage step of storing an angular difference, in a direction of rotation of the rotating body, between an installation position that is predetermined as a position at which the detector is to be installed and an installation position at which the detector is actually installed; a second acquisition step of acquiring a positional deviation of the moving body in a direction of the movement axis; a compensation step of compensating the angle of rotation based on the angular difference, the angle of rotation comprising a plurality of angles of rotation; a second storage step of storing the plurality of angles of rotation after compensation as a plurality of compensated angles of rotation, and the positional deviation as positional deviations respectively corresponding to the plurality of compensated angles of rotation, in association with each other; and a display control step of causing a display unit to display a graph showing a corresponding relationship between the plurality of compensated angles of rotation and the positional deviations that are stored in association with the plurality of compensated angles of rotation.

According to the aspects of the present invention, it is possible to observe a balance state of a rotating body of a machine tool, without using a field balancer. Further, it is possible for the balance correcting operation of the rotating body to be easily carried out by an operator.

### BRIEF DESCRIPTION OF DRAWINGS

FIG. 1 is a configuration diagram of an observation system according to an embodiment;

FIG. 2 is a simplified configuration diagram of a rotating body and a main shaft motor according to the embodiment;

FIG. 3A is a first schematic diagram for describing the detection of an angle of rotation by a detector;

FIG. 3B is a second schematic diagram for describing the detection of the angle of rotation by the detector;

FIG. 4 is a configuration diagram of the observation device according to the embodiment;

FIG. 5 is a schematic diagram illustrating an angular difference that is stored in a storage unit;

FIG. 6 is a graph illustrating the phase of an angle of rotation of the rotating body acquired by a first acquisition unit;

FIG. 7 is a graph illustrating the phase of a positional deviation of a moving body acquired by a second acquisition unit;

FIG. 8 is a graph illustrating a corresponding relationship between a plurality of angles of rotation acquired by the first acquisition unit, and the positional deviations corresponding respectively to the plurality of angles of rotation acquired by the first acquisition unit;

FIG. 9 is a graph illustrating a corresponding relationship between a plurality of compensated angles of rotation, and positional deviations corresponding respectively to the plurality of compensated angles of rotation;

FIG. 10 is a flowchart illustrating a process flow of the observation method according to the embodiment;

FIG. 11A is a first schematic diagram for explaining a balance correction operation when a detector is installed at a predetermined installation position;

FIG. 11B is a graph displayed by a display control unit in the case of FIG. 11A;

FIG. 12 is a schematic diagram for explaining a balance correction operation when a detector is not installed at a predetermined installation position;

FIG. 13 is a configuration diagram of the observation device according to an Exemplary Modification 1;

FIG. 14 is a graph obtained by reversing the polarity in the graph of FIG. 9;

FIG. 15 is a configuration diagram of an observation device according to an Exemplary Modification 3;

FIG. 16 is a graph obtained by reversing the orientation concerning a magnitude in a deviation axis of the graph of FIG. 9; and

FIG. 17 is a graph illustrating a corresponding relationship between a plurality of angles of rotation, and the positional deviations corresponding respectively to the plurality of angles of rotation.

### DETAILED DESCRIPTION OF THE INVENTION

### Embodiments

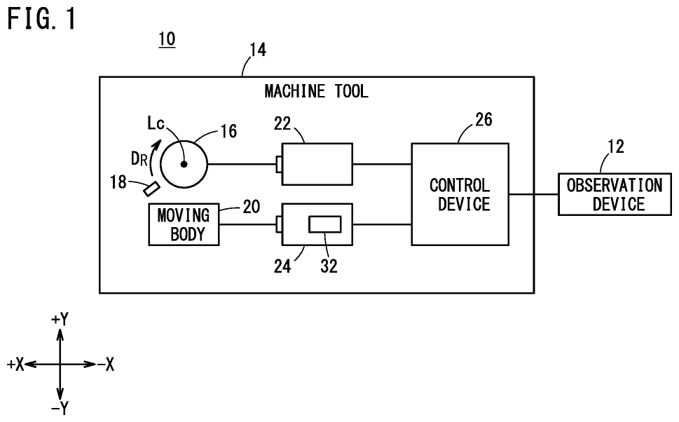

FIG. 1 is a configuration diagram of an observation system 10 according to an embodiment.

The observation system 10 includes an observation device 12 and a machine tool 14. Hereinafter, the machine tool 14 and the observation device 12 will be described sequentially in this order.

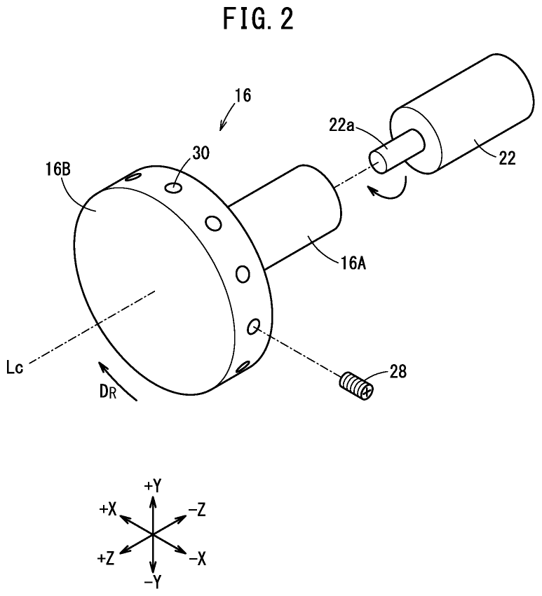

FIG. 1 illustrates not only the observation system 10, but also an X-axis and a Y-axis. Further, FIG. 2, which will be referred to later, also illustrates a Z-axis. The X-axis, the Y-axis, and the Z-axis are directional axes that are perpendicular to each other. The X-axis and the Z-axis are parallel to the horizontal plane. The Y-axis is parallel to the direction of gravity. Concerning the directional axes of each of the X-axis, the Y-axis, and the Z-axis, one direction along the directional axis is designated by a “+” sign, and the other direction is designated by a “−” sign. For example, a direction toward one side along the X-axis is represented as a “+X direction”. Further, a direction opposite to the +X direction is expressed as a “−X direction”.

The machine tool 14 is an industrial machine that produces a product by carrying out machining of a workpiece (an object to be machined). The machine tool 14 is equipped with a rotating body 16, a first detector 18, a moving body 20, a main shaft motor 22, a feeding motor 24, and a control device 26. The rotating body 16 is a member that undergoes rotation. The first detector 18 is a sensor for detecting an angle of rotation RA of the rotating body 16. The moving body 20 is a member that moves along a predetermined movement axis (movement axis). The main shaft motor 22 is an actuator (a motor) that causes the rotating body 16 to rotate. The feeding motor 24 is an actuator (a motor) that causes the moving body 20 to move. The control device 26 is a device for the purpose of controlling the main shaft motor 22 and the feeding motor 24. The machine tool 14, for example, is a lathing machine. However, the machine tool 14 according to the present embodiment is not limited to being a lathing machine.

FIG. 2 is a simplified configuration diagram of the rotating body 16 and the main shaft motor 22 according to the embodiment.

The rotating body 16 rotates centrally about a central line of rotation L_{C}. The central line of rotation L_{C} is an imaginary straight line along the Z-axis direction. An arrow (D_{R}) in FIG. 2 indicates the direction of rotation D_{R} of the rotating body 16. The rotating body 16 according to the present embodiment includes a main shaft (spindle) portion 16A, and a rotating portion 16B. The main shaft portion 16A undergoes rotation in accordance with the main shaft motor 22 being driven. The rotating portion 16B is a disk-shaped member. The rotating portion 16B is supported by the main shaft portion 16A. The rotating portion 16B is capable of rotating integrally together with the main shaft portion 16A.

The main shaft portion 16A is electrically driven. More specifically, the main shaft portion 16A undergoes rotation in accordance with the electric main shaft motor 22 being driven. However, the method of driving the main shaft portion 16A is not limited to being an electric method. For example, the method of driving the main shaft portion 16A may be an air-based method. In the case of an air-based method, the main shaft portion 16A is rotationally driven in accordance with supplied air (an air turbine). In this case, the main shaft motor 22 may be omitted from the configuration of the machine tool 14.

The main shaft portion 16A includes an end portion in the +Z direction. Such an end portion is connected to the rotating portion 16B (refer to FIG. 2). The rotating portion 16B, for example, is a face plate or a chuck portion that serves to support the workpiece.

The rotating portion 16B includes a plurality of weight attachment and detachment portions 30. The plurality of weight attachment and detachment portions 30 are arranged on a side surface (an outer peripheral surface) of the rotating portion 16B. In this instance, the side surface of the rotating portion 16B is a surface of the rotating portion 16B (refer to FIG. 2) that faces toward the X-axis direction or the Y-axis direction. Each of the plurality of weight attachment and detachment portions 30 detachably retains a balance adjustment weight (weight for balance adjustment) 28. By attaching and detaching the weight 28 to and from the rotating portion 16B, the position of the center of gravity of the rotating portion 16B changes. Consequently, a balance state (a state of balance) of the rotating portion 16B is corrected. Moreover, it should be noted that the plurality of weight attachment and detachment portions 30 may be arranged on a front surface of the rotating portion 16B, or alternatively, on a rear surface of the rotating portion 16B. In this instance, the front surface of the rotating portion 16B is a surface that faces toward the +Z direction. The rear surface of the rotating portion 16B is a surface that faces toward the −Z direction. When the plurality of weight attachment and detachment portions 30 are arranged on the front surface of the rotating portion 16B, the weight 28 is attached to and detached from the front surface of the rotating portion 16B. Further, as for the plurality of weight attachment and detachment portions 30, in the case that the plurality of weight attachment and detachment portions 30 are arranged on the rear surface of the rotating portion 16B, the weight 28 is attached to and detached from the rear surface of the rotating portion 16B.

The weight 28, for example, is a screw. In this case, each of the plurality of weight attachment and detachment portions 30 is a screw hole. In this case, the weight 28 is inserted into the weight attachment and detachment portion 30. Consequently, the weight 28 is attached to the rotating portion 16B. Further, the weight 28 is unscrewed from the weight attachment and detachment portion 30. Consequently, the weight 28 is detached from the rotating portion 16B.

The main shaft motor 22 that causes the main shaft portion 16A to rotate, for example, is a spindle motor. The main shaft motor 22 includes a shaft 22a. The shaft 22a is connected to the main shaft portion 16A. The main shaft motor 22 is capable of causing the main shaft portion 16A to be rotated along the direction of rotation D_{R} in accordance with the rotational driving of the shaft 22a.

The first detector 18, which detects the angle of rotation RA of the rotating body 16, for example, is a rotary encoder. The first detector 18 is installed at a position that differs from the rotating body 16 (the rotating portion 16B) on a plane that is parallel to the XY plane.

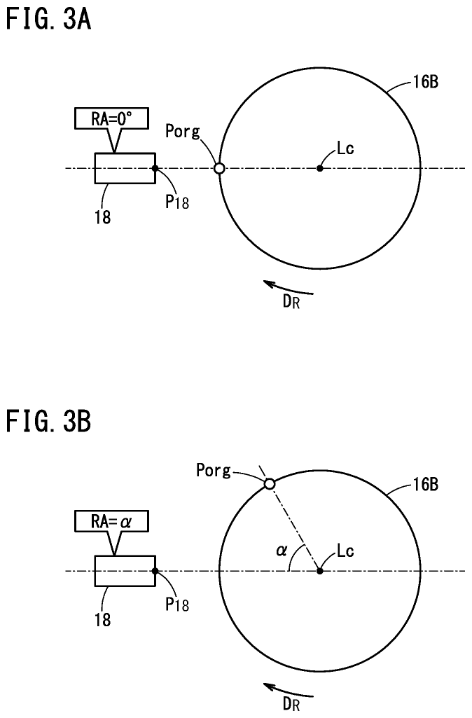

FIG. 3A is a first schematic diagram for describing the detection of an angle of rotation RA by the first detector 18. FIG. 3B is a second schematic diagram for describing the detection of the angle of rotation RA by the first detector 18.

The rotating portion 16B (the rotating body 16) has an origin point P_{org} (refer to FIG. 3A). The origin point P_{org} is a reference point (a point indicating zero degrees) of the angle of rotation RA. When the rotating portion 16B rotates, the origin point P_{org} moves along the direction of rotation D_{R}. By the rotating portion 16B being rotated, the origin point P_{org} arrives at the installation position P₁₈ of the first detector 18 in the direction of rotation D_{R} (refer to FIG. 3A). When the origin point P_{org} arrives at the installation position P₁₈, the first detector 18 outputs to the control device 26 a detection signal which indicates zero degrees as being the angle of rotation RA. Further, in the case that the origin point P_{org} is moved to a position that is a degrees ahead of the installation position P₁₈ along the direction of rotation D_{R}, the first detector 18 outputs to the control device 26 a detection signal which indicates α degrees as being the angle of rotation RA (refer to FIG. 3B).

The movement axis of the moving body 20 is an axis along a direction perpendicular to the central line of rotation LC. The moving body 20 is connected to the shaft of the feeding motor 24 via a ball screw and a nut. The ball screw is installed parallel to the movement axis of the moving body 20. The ball screw rotates together with the shaft of the feeding motor 24. The nut is screw-engaged onto the ball screw. The moving body 20 is connected to the nut. Consequently, the moving body 20 is capable of moving along the movement axis in accordance with the driving of the feeding motor 24. It should be noted that illustration of the ball screw and the nut is omitted.

The movement axis according to the present embodiment is parallel to the X-axis. Therefore, the moving body 20 moves in the +X direction or in the −X direction. The amount of movement of the moving body 20 correlates with the amount of rotation of the shaft of the feeding motor 24.

The moving body 20 is connected to (supported on) the main shaft portion 16A. Consequently, the rotating body 16 moves together with the moving body 20 along the +X direction or the −X direction.

The feeding motor 24 that causes the moving body 20 to move, for example, is a servo motor. A second detector 32 is provided in the feeding motor 24. The second detector 32 is a sensor for detecting an angle of rotation of the feeding motor 24. The second detector 32, for example, is a rotary encoder.

The control device 26 is an electronic device (a computer) including, for example, a processor, a memory, and an amplifier. The control device 26 serves to numerically control the main shaft motor 22 and the feeding motor 24. The control device 26 acquires a detection signal of the first detector 18. In accordance therewith, the control device 26 acquires the angle of rotation RA of the main shaft motor 22. Further, the control device 26 acquires a detection signal of the second detector 32. In accordance therewith, the control device 26 acquires the angle of rotation of the feeding motor 24. Furthermore, the control device 26 calculates a positional deviation PD of the moving body 20 in the X-axis direction, as will be described below.

The positional deviation PD is the deviation (difference) between an angle of rotation commanded to the feeding motor 24 by the control device 26, and an actual angle of rotation of the feeding motor 24 in accordance with such a command. The positional deviation PD is caused by, for example, vibration of the machine tool 14. By further controlling the feeding motor 24 in a manner so that the positional deviation PD comes into close proximity to zero, the control device 26 is capable of accurately controlling the position of the moving body 20 in the X-axis direction.

An exemplary configuration of the machine tool 14 has been described above. Subsequently, the observation device 12 according to the present embodiment will be described. Moreover, in the following description, unless otherwise specified in particular, the “rotating body 16” indicates the rotating portion 16B from among the main shaft portion 16A and the rotating portion 16B.

The observation device 12 is an electronic device for the purpose of observing changes in the balance state of the rotating body 16. Although the details thereof will be described later, the observation device 12 acquires the angle of rotation RA of the rotating body 16, and the positional deviation PD of the moving body 20, from the machine tool 14. Further, the observation device 12 associates the angle of rotation RA and the positional deviation PD with each other. In particular, the observation device 12 of the present embodiment compensates the acquired angle of rotation RA in accordance with the installation position P₁₈ of the first detector 18. Consequently, in the observation device 12, it becomes easy for the balance correcting operation of the rotating body 16 to be carried out by the operator. Further, the accuracy of the balance correction is improved.

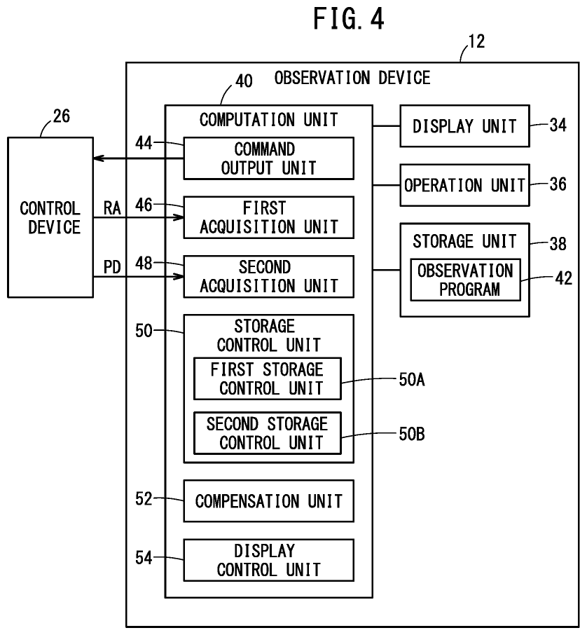

FIG. 4 is a configuration diagram of the observation device 12 according to the embodiment.

The observation device 12 is equipped with a display unit 34, an operation unit 36, a storage unit 38, and a computation unit 40.

The display unit 34, for example, is a device having a liquid crystal screen. The display unit 34 serves to display information. The screen of the display unit 34 is not limited to being a liquid crystal screen. For example, the screen of the display unit 34 may be an organic EL (OEL: Organic Electro-Luminescence) screen.

The operation unit 36 includes, for example, a keyboard, a mouse, and a touch panel. The touch panel is installed, for example, on the screen of the display unit 34. The operation unit 36 receives information that is input by the operator. In accordance with this feature, the operator is capable of appropriately inputting his or her own instructions to the observation device 12.

The storage unit 38 includes a memory. For example, the storage unit 38 includes a memory such as a RAM (Random Access Memory) or a ROM (Read Only Memory). The storage unit 38 serves to store information.

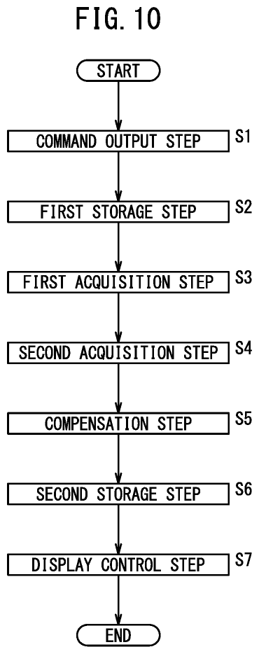

The storage unit 38 stores an observation program 42 (refer to FIG. 4). The observation program 42 is a program in order to cause the observation device 12 to execute the observation method according to the present embodiment. The observation method will be described later (see FIG. 10).

Further, as will be described next, the storage unit 38 also stores an angular difference AD. The angular difference AD is an angular difference in the direction of rotation D_{R} between the installation position Pₚᵣₑ and the installation position P₁₈. The installation position Pₚᵣₑ is a position that is determined beforehand as a position at which the first detector 18 is to be installed. The installation position P₁₈ is a position at which the first detector 18 is actually installed. The angular difference AD is input to the observation device 12 via the operation unit 36, for example, by the operator. Each of the installation position Pₚᵣₑ and the installation position P₁₈ is an absolute position with respect to the rotating body 16. Therefore, each of the installation position Pₚᵣₑ and the installation position P₁₈ does not move with the rotation of the rotating body 16.

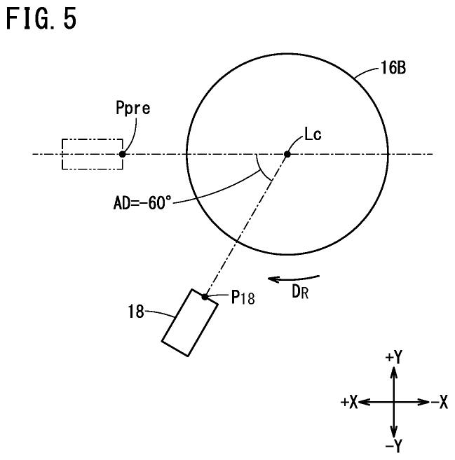

FIG. 5 is a schematic diagram illustrating the angular difference AD that is stored in the storage unit 38.

Hereinafter, a specific example of the angular difference AD will be described. FIG. 5 illustrates the positional relationship between the rotating portion 16B and the first detector 18. The installation position P₁₈ in FIG. 5 is a position that is −60 degrees from the installation position Pₚᵣₑ along the direction of rotation D_{R}. In this case, the angular difference AD is −60 degrees. Note that the angular difference AD is not limited to −60 degrees.

The storage unit 38 stores the plurality of angles of rotation RA and the positional deviations PD corresponding respectively to the plurality of angles of rotation RA. The association between the plurality of angles of rotation RA and the plurality of positional deviations PD will be described later.

The computation unit 40 includes a processor. The computation unit 40 includes a CPU (Central Processing Unit) and a GPU (Graphics Processing Unit). The computation unit 40 is equipped with a command output unit 44, a first acquisition unit 46, a second acquisition unit 48, a storage control unit 50, a compensation unit 52, and a display control unit 54. The command output unit 44 issues a command to the machine tool 14 in order to appropriately perform the observation. The first acquisition unit 46 acquires the angle of rotation RA. The second acquisition unit 48 acquires the positional deviation PD. The storage control unit 50 causes the storage unit 38 to store information as appropriate. The compensation unit 52 compensates the acquired angle of rotation RA according to the installation position P₁₈. The display control unit 54 associates the compensated angle of rotation RA with the positional deviation PD. The display control unit 54 causes the display unit 34 to display the angle of rotation RA and the position deviation PD that are associated with each other. The command output unit 44, the first acquisition unit 46, the second acquisition unit 48, the storage control unit 50, the compensation unit 52, and the display control unit 54 are realized by the observation program 42 being executed by the computation unit 40.

The command output unit 44 issues a command to the machine tool 14. Such a command includes content to cause the rotating body 16 to rotate, and content to cause the moving body 20 to be stopped at a predetermined position in the X-axis direction. The command output unit 44, for example, issues a request to the control device 26. In accordance with the request that has been input, the control device 26 controls the main shaft motor 22 and the feeding motor 24.

When the rotating body 16 rotates based on the command from the command output unit 44, vibrations occur which are caused by the rotation of the rotating body 16. These vibrations are transmitted from the rotating body 16 to the moving body 20. As a result, the aforementioned positional deviation PD occurs.

Further, when the moving body 20 is stopped based on the command from the command output unit 44, vibrations of the moving body 20 caused by factors other than the rotation of the rotating body 16 are suppressed. In other words, the command output unit 44 is capable of easily bringing about a situation in which the positional deviation PD caused by the rotation of the rotating body 16 can be easily observed.

The first acquisition unit 46 acquires the plurality of angles of rotation RA, based on the detection signal of the first detector 18. The first acquisition unit 46, for example, acquires from the control device 26 the angle of rotation RA that was calculated by the control device 26. However, the first acquisition unit 46 may acquire the detection signal from the control device 26 or the first detector 18. In that case, the first acquisition unit 46 may calculate the angle of rotation RA, based on the acquired detection signal.

Preferably, an acquisition cycle of the plurality of angles of rotation RA by the first acquisition unit 46 should be as short as possible. For example, between an acquisition cycle in which the angles of rotation RA are acquired in units of 1 degree (0 degrees, 1 degree, 2 degrees, . . . , 359 degrees) and an acquisition cycle in which the angles of rotation RA are acquired in units of 0.1 degree (0.0 degrees, 0.1 degrees, 0.2 degrees, . . . , 359.9 degrees), the latter acquisition cycle is preferable. In the case that the acquisition cycle of the angles of rotation RA is short, the balance state of the rotating body 16 can be accurately observed. However, the acquisition period of the angles of rotation RA is limited in accordance with the detection period of the first detector 18 and the resolution of the first detector 18.

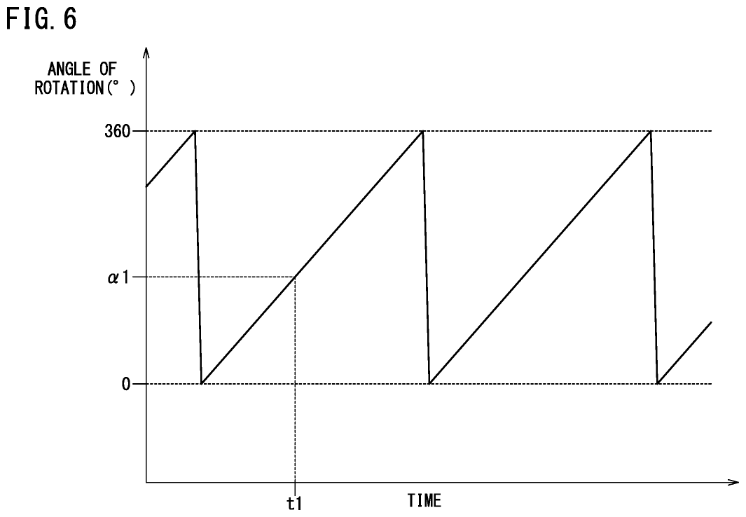

FIG. 6 is a graph illustrating the phase of the angle of rotation RA of the rotating body 16 acquired by the first acquisition unit 46.

The graph of FIG. 6 includes a vertical axis representing the angle of rotation RA and a horizontal axis representing time. The graph in FIG. 6 indicates a plurality of angles of rotation RA acquired along a time series. For example, the angle of rotation RA of the rotating body 16 at a point in time t1 is the angle “α1”. The graph in FIG. 6 can be created based on the plurality of angles of rotation RA that are acquired by the first acquisition unit 46. The range of the vertical axis in FIG. 6 is 0 degrees to 360 degrees. The range of the vertical axis in FIG. 6 is not limited to being 0 degrees to 360 degrees. For example, the vertical axis in FIG. 6 may include an angle of rotation RA of greater than or equal to 361 degrees. A vertical axis containing an angle of rotation RA of greater than or equal to 361 degrees is used, for example, in the case that the first detector 18 is capable of detecting angles of rotation RA of greater than or equal to 361 degrees.

The second acquisition unit 48 acquires the positional deviation PD. The second acquisition unit 48, for example, acquires from the control device 26 the positional deviation PD that was calculated by the control device 26. However, the second acquisition unit 48 may acquire a control command for the feeding motor 24, and the detection signal of the second detector 32. In that case, the second acquisition unit 48 may calculate the positional deviation PD based on the acquired control command, and the detection signal.

It is preferable that the acquisition cycle of the plurality of positional deviations PD by the second acquisition unit 48 be synchronized with the acquisition cycle of the plurality of angles of rotation RA by the first acquisition unit 46. However, the acquisition cycle of the plurality of positional deviations PD by the second acquisition unit 48 need not necessarily be synchronized with the acquisition cycle of the plurality of angles of rotation RA by the first acquisition unit 46.

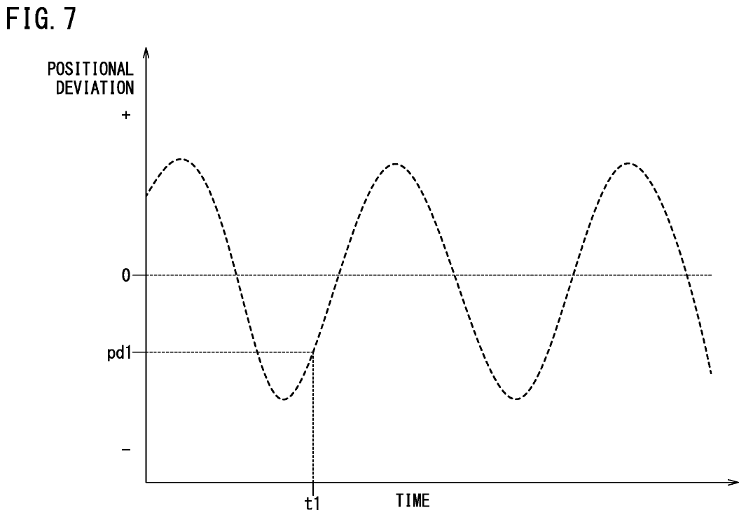

FIG. 7 is a graph illustrating the phase of the positional deviation PD of the moving body 20 acquired by the second acquisition unit 48.

The graph of FIG. 7 includes a vertical axis representing the positional deviation PD, and a horizontal axis representing time. The graph in FIG. 7 shows a plurality of positional deviations PD acquired along a time series. For example, the positional deviation PD at the point in time t1 is pd1. The point in time t1 in FIG. 7 and the point in time t1 in FIG. 6 are the same time. The graph in FIG. 7 can be created based on the acquisition result of a plurality of positional deviations PD by the second acquisition unit 48.

The storage control unit 50 includes a first storage control unit 50A and a second storage control unit 50B (refer to FIG. 4). The first storage control unit 50A causes the angular difference AD to be stored in the storage unit 38. For example, the first storage control unit 50A causes the angular difference AD, which is input by the operator via the operation unit 36, to be stored in the storage unit 38. As explained next, the second storage control unit 50B causes the plurality of angles of rotation RA and the positional deviations PD to be stored in association with each other in the storage unit 38.

The second storage control unit 50B associates the plurality of angles of rotation RA (refer to FIG. 6) and the plurality of positional deviations PD (refer to FIG. 7) with each other on the time axis. For example, the second storage control unit 50B associates an angle of rotation α1 acquired at the point in time t1 with a positional deviation pd1 also acquired at the point in time t1 (refer to FIG. 6 and FIG. 7). Further, the second storage control unit 50B causes the angles of rotation RA and the positional deviations PD that are associated with each other to be stored in the storage unit 38. The positional deviation pd1 indicates a balance state of the rotating body 16 in the case that the angle of rotation RA=α1.

Moreover, in the present embodiment, there is a case where the acquisition cycle of the first acquisition unit 46 and the acquisition cycle of the second acquisition unit 48 may not be synchronized. In that case, there is a possibility that an angle of rotation RA and a positional deviation PD that are acquired at the same time do not exist. In that case, in the second storage control unit 50B, the angle of rotation RA and the positional deviation PD that are acquired in close proximity to each other on the time axis may be associated with each other. Further, using linear interpolation (straight-line interpolation), the second storage control unit 50B may interpolate (estimate) the positional deviation PD that is associated with the point in time at which the angle of rotation RA is acquired.

Further, a difference in time exists between when the balance state of the rotating body 16 changes due to a vibration of the rotating body 16, and when such a vibration is transmitted to the moving body 20. Accordingly, the positional deviation PD representing the balance state of the rotating body 16 at a certain angle of rotation RA may be detected after such an angle of rotation RA has been detected. Based on the aforementioned factor, it is preferable that the association between the angle of rotation RA and the positional deviation PD be carried out in consideration of the above-described time difference. However, in order to simplify the description insofar as possible, in the present embodiment, such a time difference will be ignored.

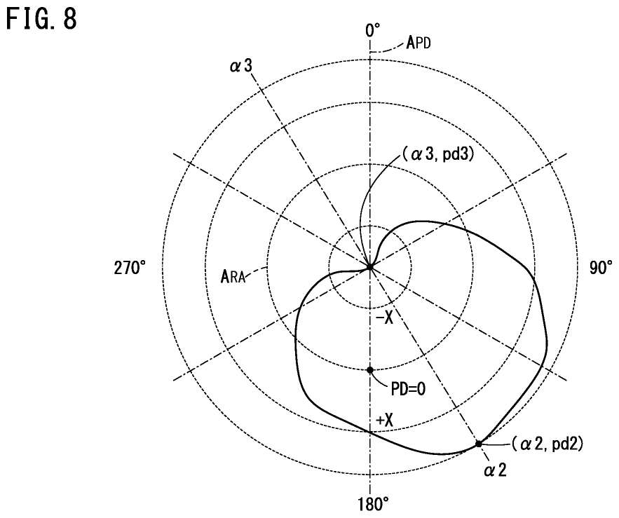

FIG. 8 is a graph illustrating a corresponding relationship between a plurality of angles of rotation RA acquired by the first acquisition unit 46, and the positional deviations PD corresponding respectively to the plurality of angles of rotation RA acquired by the first acquisition unit 46.

The graph of FIG. 8 includes an angular axial line (angular axis) A_{RA}, and a deviation axial line (deviation axis) A_{PD}. The angular axis A_{RA} represents, on a circle, a magnitude of the angle of rotation RA in the case that the positional deviation PD is zero. The deviation axis A_{PD} represents, on a normal line of the circle, a magnitude of the positional deviation PD. The graph in FIG. 8 can be created based on the results of associating the plurality of angles of rotation RA with the plurality of positional deviations PD.

The displayed range of the angles of rotation RA included on the angular axis A_{RA} is 0 to 360 degrees. More specifically, the displayed range of the angles of rotation RA included on the angular axis A_{RA} corresponds to one rotation of the rotating body 16. The graph of FIG. 8 includes a plurality of angular axes A_{RA} (circles) with diameters that differ from each other. However, the number of the angular axes ARA may also be one.

An intersection of one of the angular axes A_{RA} (a reference circle) and the deviation axis A_{PD} indicates a reference point (PD=0) of the positional deviation PD. A positional deviation PD in the +X direction is plotted outside of the reference circle. The positional deviation PD in the +X direction becomes greater in the +X direction as it is plotted farther away from the reference circle. A positional deviation PD in the −X direction is plotted inside of the reference circle. The positional deviation PD in the −X direction becomes greater in the −X direction as it is plotted farther away from the reference circle. The graph of FIG. 8 includes a plurality of deviation axes A_{PD} intersecting in an asterisk pattern. However, the number of the deviation axes APD may also be one.

A point (α2, pd2) in FIG. 8 represents a correspondence between the angle of rotation RA=α2 and the positional deviation PD=pd2. A point (α3, pd3) in FIG. 8 represents a correspondence between the angle of rotation RA=α3 and the positional deviation PD=pd3. Among the plurality of positional deviations PD shown in FIG. 8, pd2 is the maximum value in the +X direction. Among the plurality of positional deviations PD shown in FIG. 8, pd3 is the maximum value in the −X direction.

The compensation unit 52 compensates the plurality of angles of rotation RA based on the angle difference AD. For example, the angular difference AD stored in the storage unit 38 is an angle of −60 degrees. In this case, the compensation unit 52 compensates the angle of rotation RA stored in the storage unit 38 in correspondence to each of the plurality of positional deviations PD, with the angle of −60 degrees. In addition, the compensation unit 52 requests the second storage control unit 50B to update the corresponding relationship between the angle of rotation RA and the positional deviation PD, based on the compensation result. Accordingly, the corresponding relationship between the plurality of compensated angles of rotation RA and the positional deviations PD corresponding to the plurality of compensated angles of rotation RA is stored in the storage unit 38.

Each time the first acquisition unit 46 acquires the angle of rotation RA, the compensation unit 52 may compensate the acquired angle of rotation RA based on the angular difference AD. In this case, the second storage control unit 50B can associate the compensated angle of rotation RA with the positional deviation PD without associating the angle of rotation RA before compensation with the positional deviation PD.

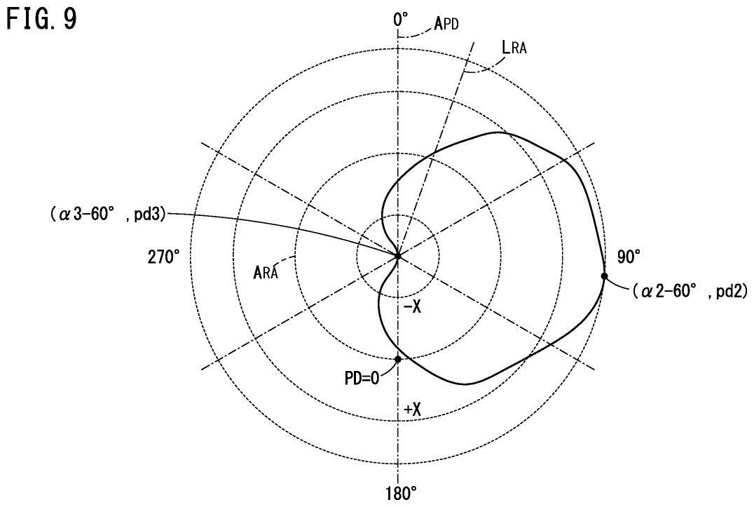

The display control unit 54 causes the display unit 34 to display thereon a graph (refer to FIG. 9) showing the corresponding relationship between the plurality of compensated angles of rotation RA, and the plurality of positional deviations PD associated respectively with the plurality of compensated angles of rotation RA. In this instance, the graph that is displayed on the display unit 34 represents an observation result of the balance state of the rotating body 16. The corresponding relationship indicated by the graph is the corresponding relationship that is stored in the storage unit 38 by the second storage control unit 50B.

FIG. 9 is a graph illustrating the corresponding relationship between the plurality of compensated angles of rotation RA, and the positional deviations PD corresponding respectively to the plurality of compensated angles of rotation RA.

The graph of FIG. 9 is created by compensating each angle of rotation RA in the graph of FIG. 8 based on the angular difference AD=−60 degrees. As shown in FIG. 9, when the compensation based on the angular difference AD is performed, the phase of the positional deviation PD shown in the graph is shifted by the angular difference AD (−60 degrees).

When the compensation is performed by the compensation unit 52, the display control unit 54 causes the display unit 34 to display the graph after the compensation (FIG. 9) instead of the graph before the compensation (FIG. 8). In addition, the display control unit 54 may cause an auxiliary line L_{RA} to be further displayed on the graph (refer to FIG. 9). The auxiliary line L_{RA} indicates a current rotational position (rotational angle RA) of the rotating body 16. By referring to the auxiliary line L_{RA}, the operator is capable of easily grasping the current rotational position of the rotating body 16. The current rotational position is a rotational position of the rotating body 16 that is not compensated by the compensation unit 52. That is, the current rotational position is the angle of rotation RA of the rotating body 16 detected by the first detector 18.

The graph of FIG. 9 is created on the basis of the angles of rotation RA and the positional deviations PD. The angles of rotation RA and the positional deviations PD are numerical information that can be acquired from the machine tool 14. Accordingly, the observation device 12 is capable of observing the balance state of the rotating body 16, without the need for a separate device such as a field balancer.

Observation of the balance state of the rotating body 16 by the observation device 12 can be executed by connecting the observation device 12 and the control device 26 in a manner so as to be capable of communicating with each other. In this case, it is not necessary to use a field balancer. Accordingly, the observation result of the balance state of the rotating body 16 does not depend on the way the field balancer is attached and the attachment position thereof. Consequently, the observation device 12 according to the present embodiment can stably acquire a highly accurate observation result.

A description of an exemplary configuration of the observation device 12 according to the present embodiment has been presented above. Subsequently, an observation method performed by the observation device 12 will be described.

FIG. 10 is a flowchart illustrating a process flow of the observation method according to the embodiment.

The observation method includes a command output step S1, a first storage step S2, a first acquisition step S3, a second acquisition step S4, a compensation step S5, a second storage step S6, and a display control step S7 (refer to FIG. 10).

In the command output step S1, the command output unit 44 issues a command to the machine tool 14. Such a command includes content to cause the rotating body 16 to be rotated, and content to cause the moving body 20 to be stopped at a predetermined position. The command output step S1 is started, for example, by the operator providing an instruction to the observation device 12 via the operation unit 36.

In the first storage step S2, the first storage control unit 50A stores the angular difference AD. Note that the execution timing of the first storage step S2 is not particularly limited as long as the first storage step S2 is completed by the start of the compensation step S5 described later.

In the first acquisition step S3, the first acquisition unit 46 acquires the plurality of angles of rotation RA on the basis of detection signals from the first detector 18. The first acquisition step S3 is executed after the command output step S1.

In the second acquisition step S4, the second acquisition unit 48 acquires the plurality of positional deviations PD. Here, each of the plurality of positional deviations PD is a positional deviation of the moving body 20 along the movement axis (X-axis). The second acquisition step S4 is executed after the command output step S1. In a case that the second acquisition step S4 is executed in parallel with the first acquisition step S3, it is efficient in terms of time. Further, it is preferable that the acquisition cycle of the angle of rotation RA and the acquisition cycle of the positional deviation PD be synchronized with each other. Thus, the observation accuracy of the observation result displayed in the subsequent display control step S7 is improved.

In the compensation step S5, the compensation unit 52 compensates the plurality of angles of rotation RA based on the angular difference AD. The compensation step S5 is performed after the start of the first acquisition step S3.

In the second storage step S6, the second storage control unit 50B associates the plurality of angles of rotation RA with the positional deviations PD corresponding respectively to the plurality of angles of rotations RA, and stores them in the storage unit 38. The second storage step S6 is performed after the compensation step S5. Therefore, the plurality of angles of rotation RA in the second storage step S6 are the plurality of rotation angles RA after the compensation.

In the display control step S7, the display control unit 54 causes the display unit 34 to display a graph showing the corresponding relationship between the plurality of angles of rotation RA and the plurality of positional deviations PD. The display control step S7 is executed after the start of the second storage step S6. A description of an exemplary configuration of the observation method according to the present embodiment has been presented above.

As will be described hereinafter, the observation device 12 and the observation method contribute to the operator easily carrying out the balance correcting operation of the rotating body 16.

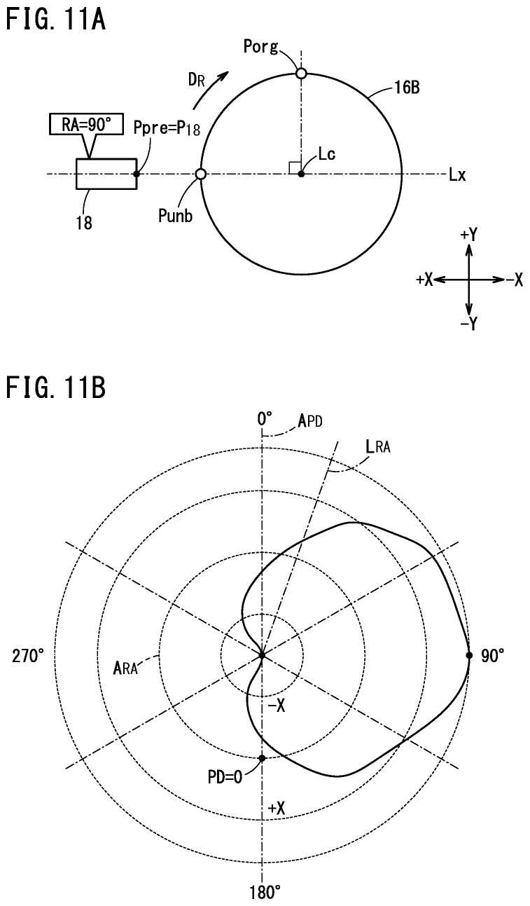

FIG. 11A is a first schematic diagram for explaining a balance correction operation when the first detector 18 is installed at the predetermined installation position Pₚᵣₑ. FIG. 11B is a graph displayed by the display control unit 54 in the case of FIG. 11A.

The balance correction operation performed by the operator when the first detector 18 is installed at the predetermined installation position Pₚᵣₑ will be described below. For the purposes of this illustration, reference will be made to FIG. 11A and FIG. 11B.

A line L_{X} is shown in FIG. 11A. The line L_{X} is an imaginary straight line parallel to the X-axis. The line L_{X} passes through the central line of rotation L_{C}. The installation position Pₚᵣₑ in FIG. 11A is on the line L_{X}. In addition, the installation position Pₚᵣₑ in FIG. 11A is a position that is shifted toward the +X direction from the central line of rotation L_{C}, on the rotation portion 16B. In this example, the first detector 18 is installed at the installation position Pₚᵣₑ (Pₚᵣₑ=P₁₈).

The plurality of angles of rotation RA and the plurality of positional deviations PD are associated with each other on the time axis. Thus, when the balance state is observed in this example of FIG. 11A, the graph of FIG. 11B is displayed on the display unit 34. In the graph shown in FIG. 11B, the angle of rotation RA=90 degrees, and the maximum value of the positional deviation PD in the +X direction correspond to each other.

At a point in time when the positional deviation PD in the +X direction becomes maximized, in the following description, a position on the line L_{X} more in the +X direction than the central line of rotation L_{C} will be referred to as an “unbalanced position P_{unb}”. The unbalanced position P_{unb} is a position (rotational position) on the rotating portion 16B. Accompanying the rotation of the rotating portion 16B, the unbalanced position P_{unb} moves along the direction of rotation D_{R}. In the example shown in FIG. 11A, as noted previously, the point in time when the positional deviation PD in the +X direction becomes maximum is a point in time when the angle of rotation RA has become 90 degrees.

In this case, at the point in time when the angle of rotation RA is an angle of 90 degrees, the operator attaches the weight 28 to the weight attachment and detachment portion 30 that is located on the line L_{X} and more in the −X direction than the central line of rotation L_{C}. By such attaching of the weight, the unbalanced state of the rotating portion 16B in FIG. 11A is efficiently adjusted. The weight attachment and detachment portion 30 is positioned at an angle of 180 degrees along the direction of rotation D_{R} from the unbalanced position P_{unb}. In other words, in the case that the rotating portion 16B is in an unbalanced state, the position of the center of gravity of the rotating portion 16B is shifted in a direction toward the unbalanced position P_{unb} as viewed from the central line of rotation L_{C}. Accordingly, the operator attaches the weight 28 into the weight attachment and detachment portion 30 that is positioned at an angle of 180 degrees along the direction of rotation D_{R} from the unbalanced position P_{unb}. Consequently, the position of the center of gravity of the rotating portion 16B is efficiently brought into close proximity to the position of the central line of rotation L_{C}.

The installation position P₁₈ in FIG. 11A is on the line L_{X} and more in the +X direction than the central line of rotation L_{C}. Therefore, when the angle of rotation RA reaches 90 degrees, the unbalanced position P_{unb} reaches the same position as the installation position P₁₈ in the direction of rotation D_{R}. In this case, the first detector 18 serves as a marker for the operator. That is, the operator attaches the weight 28 to the weight attachment and detachment portion 30 that is at a position of 180 degrees along the direction of rotation D_{R} from the first detector 18. As a result, the weight 28 is attached to the weight attachment and detachment portion 30 located at a position of 180 degrees from the unbalanced position P_{unb} along the direction of rotation D_{R}. Therefore, the operator can suitably correct the balance state.

Moreover, in this example, the installation position P₁₈ is the same position as the installation position Pₚᵣₑ. Therefore, the installation position P₁₈ is located on the line L_{X} and more in the +X direction than the rotating portion 16B. In this case, the angle of rotation RA corresponding to the maximum value of the positional deviation PD in the +X direction coincides with the angle of rotation RA at which the unbalanced position P_{unb} arrives at the installation position P₁₈ in the direction of rotation D_{R}. Therefore, the operator operates the machine tool 14 while referring to the angle of rotation RA detected by the first detector 18. Thus, the operator can easily align the unbalanced position P_{unb} with the installation position P₁₈ in the direction of rotation D_{R}. Therefore, the operator is capable of easily carrying out the correcting operation of the unbalanced state.

The operator may remove the weight 28 located at the unbalanced position P_{unb} in the direction of rotation D_{R}, from the rotating portion 16B. As a result, the operator can efficiently bring the position of the center of gravity of the rotating portion 16B close to the position of the central line of rotation L_{C}. In the example of FIG. 11A, when the angle of rotation RA reaches 90 degrees, the operator removes the weight 28 from the weight attachment and detachment portion 30 that is at the same position as the installation position Pₚᵣₑ in the direction of rotation D_{R}. Accordingly, the operator can remove the weight 28 located at the unbalanced position P_{unb} in the direction of rotation D_{R}, from the rotating portion 16B.

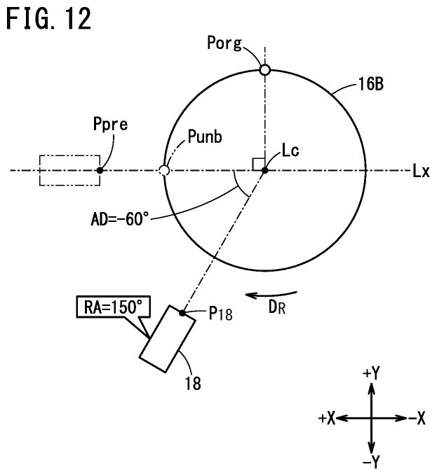

FIG. 12 is a schematic diagram for explaining the balance correction operation when the first detector 18 is not installed at the predetermined installation position Pₚᵣₑ.

Next, with reference to FIG. 12, the balance correction operation when the first detector 18 is not installed at the predetermined installation position Pₚᵣₑ will be described. The positional relationship between the origin point P_{org}, the unbalanced position P_{unb}, and the installation position Pₚᵣₑ in FIG. 12 is the same as that illustrated in FIG. 11A. However, in the example of FIG. 12, the installation position P₁₈ of the first detector 18 is different from the predetermined installation position Pₚᵣₑ. In the example of FIG. 12, the angular difference AD is −60 degrees.

At the point in time when the angle of rotation RA has reached an angle of 150 degrees, the unbalanced position P_{unb} shown in FIG. 12 arrives at a position on the line L_{X} in the +X direction from the central line of rotation L_{C}. Therefore, in the case of FIG. 12, the positional deviation PD in the +X direction is maximum at the time point when the angle of rotation RA is 150 degrees. However, if the angle of rotation RA is not compensated based on the angular difference AD, it is difficult for the operator to correct the balance state of the rotating portion 16B. The reason for this is as follows.

At the time point when the angle of rotation RA is 150 degrees, the unbalanced position P_{unb} in FIG. 12 does not coincide with the installation position P₁₈ in the direction of rotation D_{R}. In this case, the weight attachment and detachment portion 30 located at a position of 180 degrees from the installation position P₁₈ along the direction of rotation D_{R} is different from the weight attachment and detachment portion 30 located at a position of 180 degrees from the unbalance position P_{unb} along the direction of rotation D_{R}. However, using the first detector 18 as a mark, the operator attaches the weight 28 to the weight attachment and detachment portion 30 located at a position of 180 degrees from the installation position P₁₈ in the direction of rotation D_{R}. As a result, the weight 28 fails to be attached to the weight attachment and detachment portion 30 located at a position of 180 degrees from the unbalanced position P_{unb} along the direction of rotation D_{R}.

In this regard, the observation device 12 of the present embodiment can show to the operator the corresponding relationship between the plurality of rotation angles RA compensated based on the angular difference AD and the positional deviations PD corresponding respectively to the compensated angles of rotation RA.

The compensated angle of rotation RA corresponding to the maximum value of the positional deviation PD in the +X direction indicates the angle of rotation RA at which the unbalanced position P_{unb} and the installation position P₁₈ are located at the same position in the direction of rotation D_{R}. For example, in the example of FIG. 12, when the angle of rotation RA is 90 degrees (=150 degrees−60 degrees), the unbalanced position P_{unb} and the installation position P₁₈ are the same position in the direction of rotation D_{R}.

Therefore, in the case of FIG. 12, the operator adjusts the angle of rotation RA to 90 degrees. Thus, the unbalanced position P_{unb} and the installation position P₁₈ are located at the same position in the direction of rotation D_{R}. As a result, even when the installation position P₁₈ of the first detector 18 is different from the installation position Pₚᵣₑ, the operator can suitably perform the balance correction operation in the same manner as the case where the first detector 18 is installed at the installation position Pₚᵣₑ.

As noted previously, according to the present embodiment, the observation device 12 and the observation method are provided. The observation device 12 executes the observation method. Consequently, the observation device 12 observes the balance state of the rotating body 16 of the machine tool 14, without the presence of a field balancer. As a result, the observation device 12 facilitates the balance correcting operation of the rotating body 16 to be carried out by the operator.

### [Exemplary Modifications]

Hereinafter, a description will be given concerning exemplary modifications of the embodiment. However, explanations that overlap with those of the embodiment will be omitted insofar as possible in the following description. Unless otherwise specified, the same reference numerals as in the embodiment are used in referring to the constituent elements that have already been described in the embodiment.

### (Exemplary Modification 1)

In the following, the term “polarity” will be described. Further, based on such a description, the observation device 12 of the present exemplary modification will be described. Moreover, in the same manner as in the embodiment (refer to FIG. 1), the movement axis is the X-axis.

The polarity is information that determines which direction of the two directions along the X axis is the +X direction (the first direction) (or the −X direction (the second direction)). The positive and negative signs of the positional deviation PD are determined in accordance with this polarity. For example, when a positional deviation PD occurs in one direction along the X-axis, if the one direction is defined as the +X direction in the polarity, the positional deviation PD is expressed with a negative polarity (negative number), based on the polarity. More specifically, such a negative positional deviation PD represents a shifting in an opposite direction to the +X direction. Further, when a positional deviation PD occurs in one direction along the X-axis, if the one direction is defined as the −X direction in the polarity, the positional deviation PD is expressed with a positive polarity (positive number), based on the polarity. More specifically, such a positive positional deviation PD represents a shifting in an opposite direction to the −X direction.

The control device 26 calculates the positional deviation PD on the basis of the polarity. Accordingly, the control device 26 possesses information in relation to the polarity. In this case, the observation device 12 is capable of acquiring the information on the polarity from the control device 26. In this instance, for example, concerning two of the machine tools 14, there is a case that they may have polarity settings that are opposite from each other. In this case, even if each of the absolute direction and the absolute value of the positional deviation PD acquired from each of the two machine tools 14 is exactly the same in the two machine tools, the positive and negative signs of the observation results (graphs) of the balance states of the two machine tools 14 are mutually inversed.

Based on the foregoing description, the observation device 12 of the present exemplary modification will be described.

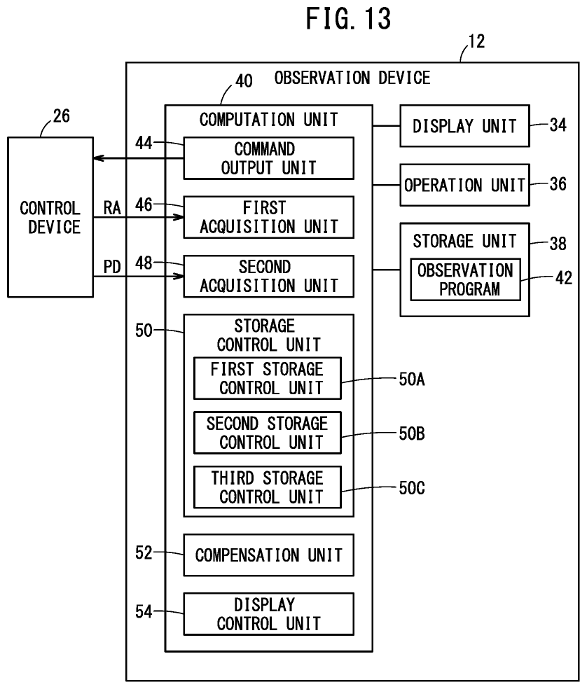

FIG. 13 is a configuration diagram of the observation device 12 according to an Exemplary Modification 1.

The storage control unit 50 according to the present exemplary modification further includes a third storage control unit 50C (refer to FIG. 13). The third storage control unit 50C causes the storage unit 38 to store therein the polarities in the +X direction and the −X direction along the X-axis. In accordance with this feature, according to the present exemplary modification, the polarities concerning the observation device 12 are stored in the storage unit 38.

The polarity is set in the machine tool 14 based on, for example, a program. In this case, the third storage control unit 50C stores the polarity based on the program in the storage unit 38. However, the operator may designate (specify) the polarity via the operation unit 36. In this case, the third storage control unit 50C may store the polarity designated by the operator in the storage unit 38.

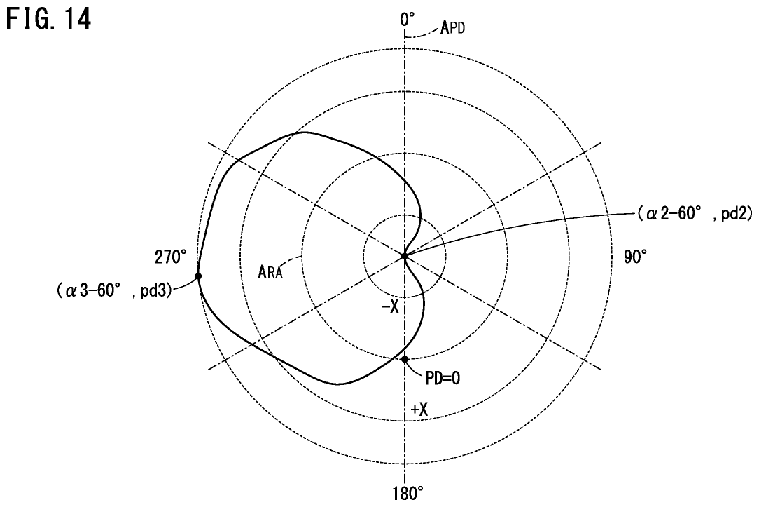

FIG. 14 is a graph obtained by reversing the polarity in the graph of FIG. 9.

In the case that the display unit 34 is made to display the graph, the display control unit 54 compares the polarity set in the machine tool 14 and the polarity that is stored in the storage unit 38. If the polarity set in the machine tool 14 and the polarity stored in the storage unit 38 are opposite to each other, the display control unit 54 causes the polarity concerning the plurality of positional deviations PD displayed on the display unit 34 to be inverted in accordance with the polarity that is stored in the storage unit 38. For example, the display control unit 54 inverts the polarity of the positional deviation PD in FIG. 9. In this case, the graph of FIG. 14 is displayed on the display unit 34.

In accordance with such features, insofar as the same observation device 12 is used, even if the observation is carried out on a plurality of machine tools 14 the polarities of which are different, the operator can refer to the observation results with a unified polarity. In this case, the “+” sign and the “−” sign in FIG. 14 represent the polarity that is set in the observation device 12.

### (Exemplary Modification 2)

In relation to the Exemplary Modification 1, the second acquisition unit 48 and the second storage control unit 50B may refer to the polarity that is stored in the storage unit 38 by the third storage control unit 50C. For example, the second acquisition unit 48 may change the positive and the negative of the positional deviation PD in accordance with the polarity that is set in the observation device 12, at the point in time when the positional deviation PD is acquired. Further, for example, the second storage control unit 50B may change the positive and the negative of the positional deviation PD in accordance with the polarity that is set in the observation device 12 at the point in time when the angle of rotation RA is associated with the positional deviation PD.

### (Exemplary Modification 3)

The positive and negative of the positional deviation PD according to Exemplary Modifications 1 and 2 is reversed in accordance with the polarity. However, instead of the positive and negative of the positional deviation PD, the axes of the graph showing the observation result may be reversed in accordance with the polarity. Based on this, a description of the present exemplary modification will be presented below. Moreover, in the following, the polarity of the observation device 12 is previously stored in the storage unit 38.

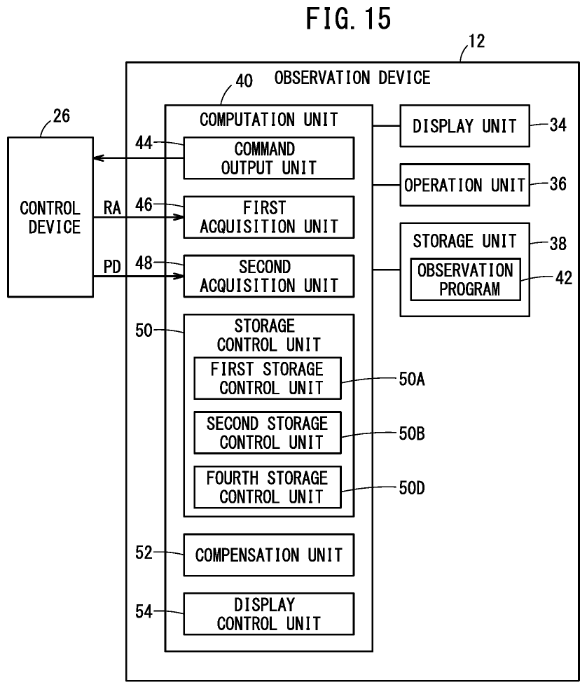

FIG. 15 is a configuration diagram of the observation device 12 according to an Exemplary Modification 3.

The storage control unit 50 according to the present exemplary modification further includes a fourth storage control unit 50D (refer to FIG. 15). The fourth storage control unit 50D causes the orientation of the deviation axis A_{PD} to be stored in the storage unit 38 (refer to FIG. 9). More specifically, the fourth storage control unit 50D causes the orientation concerning the magnitude of the positional deviation PD indicated by the deviation axis A_{PD} to be stored in the storage unit 38. Moreover, it should be noted, in a graph having a form that differs from that shown in FIG. 9, the magnitude of the positional deviation PD may be represented by an axial line other than the deviation axis A_{PD}. In this case, the fourth storage control unit 50D may cause the storage unit 38 to store the orientation (i.e., which direction is plus (or minus)) concerning the magnitude in the axial line indicating the magnitude of the positional deviation PD.

In the Exemplary Modification 1, the polarity that is set in the machine tool 14 and the polarity that is stored in the storage unit 38 are compared by the display control unit 54. In a similar manner, the fourth storage control unit 50D compares the polarity that is set in the machine tool 14, and the polarity that is stored in the storage unit 38. If the polarity that is set in the machine tool 14 and the polarity that is stored in the storage unit 38 are opposite to each other, the fourth storage control unit 50D determines the orientation of the deviation axis A_{PD} in accordance with the polarity that is stored in the storage unit 38. Further, the fourth storage control unit 50D causes the determined orientation of the deviation axis A_{PD} to be stored in the storage unit 38. Moreover, the observation method according to the embodiment may further include an operation step of allowing the operator to specify an orientation concerning the magnitude via the operation unit 36. In this case, the fourth storage control unit 50D may cause the storage unit 38 to store the orientation concerning the magnitude that is specified in the operation step.

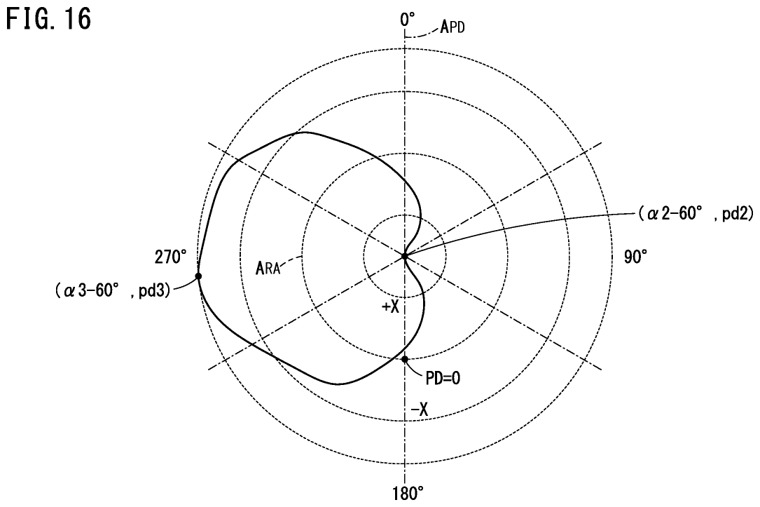

FIG. 16 is a graph obtained by reversing the orientation concerning the magnitude (plus/minus) in the deviation axis A_{PD} of the graph of FIG. 9.

In the case that the display unit 34 is made to display the graph, the display control unit 54 refers to the direction of the deviation axis line A_{PD} that is stored in the storage unit 38. The display control unit 54 determines the region of the positive polarity and the region of the negative polarity in accordance with the direction of the deviation axis line A_{PD} that has been referred to. In this case, the graph of FIG. 16 is displayed on the display unit 34 instead of the graph of FIG. 9.

According to the present exemplary modification, the display control unit 54 changes the direction of the deviation axis line A_{PD} in accordance with the polarity that is set in the machine tool 14. For example, in the deviation axis line A_{PD} shown in FIG. 9, the direction toward the center of the angular axis line A_{RA} is a direction of a negative polarity. In this instance, in the case that the polarity that is set in the machine tool 14 and the polarity that is stored in the storage unit 38 are opposite to each other, the direction of the negative polarity is changed to a direction oriented radially outward of the angular axis line A_{RA} (FIG. 16). In this case, the plus sign (+) and the minus sign (−) shown in FIG. 16 represent the polarity that is set in the machine tool 14.

### (Exemplary Modification 4)

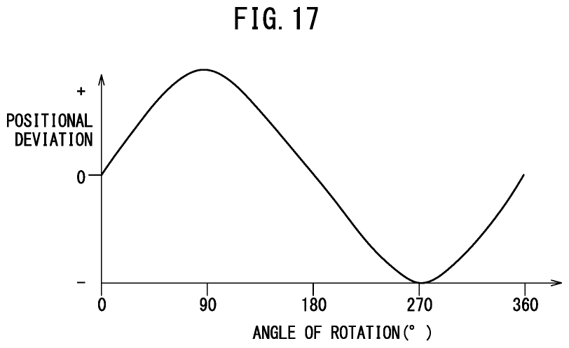

FIG. 17 is a graph illustrating a corresponding relationship between the plurality of angles of rotation RA and the positional deviations PD corresponding respectively to the plurality of angles of rotation RA.

The formulation of the graph showing the observation results is not limited to the format shown in FIG. 8 or FIG. 9. For example, the corresponding relationship between the plurality of angles of rotation RA and the plurality of positional deviations PD may be represented using the formulation shown in FIG. 17. The graph of FIG. 17 includes a vertical axis representing the positional deviation PD, and a horizontal axis representing the angle of rotation RA.

The display control unit 54 may cause both the graph of FIG. 9 and the graph of FIG. 17 to be displayed on the display unit 34. Further, the display control unit 54 may allow the operator to select the formulation of the graph to be displayed on the display unit 34. In that case, the operation unit 36 may receive a selection operation made by the operator.

### (Exemplary Modification 5)

The method by which the current angle of rotation RA of the rotating body 16 is indicated to the operator is not limited to causing the auxiliary line LA to be displayed (see FIG. 9). For example, the display control unit 54 may cause numerical values indicating the angle of rotation RA to be displayed on the screen of the display unit 34. Further, for example, the display control unit 54 may cause an icon that moves along a circle represented by the angular axis A_{RA} to be displayed on the screen of the display unit 34.

### (Exemplary Modification 6)

In the embodiment, the predetermined installation position Pₚᵣₑ of the first detector 18 is on the line L_{X}, and positioned more in the +X direction than the rotating portion 16B. However, the installation position Pₚᵣₑ is not limited to this position. For example, the installation position Pₚᵣₑ may be on the line L_{X}, and may be positioned more in the −X direction than the rotating portion 16B.

### (Exemplary Modification 7)

The movement axis of the moving body 20 is not limited to being the X-axis, insofar as it is a directional axis perpendicular to the central line of rotation L_{C}. For example, the movement axis may be the Y-axis. In that case, the ball screw (refer to the embodiment) is installed parallel to the Y-axis. In this case, the installation position Pₚᵣₑ of the first detector 18, for example, is a position on a line passing through the central line of rotation L_{C} and parallel to the Y-axis, and further, which is more in the +Y direction or the −Y direction than the rotating portion 16B. In the case that the movement axis is the Y-axis, the positional deviation PD indicates a shift in the position of the moving body 20 in the Y-axis direction. In this case, the positional deviation PD becomes maximum in the case that the unbalanced position P_{unb} reaches a position on a line passing through the central line of rotation L_{C} and parallel to the Y-axis line. By attaching the weight 28 to a position that is at an angle of 180 degrees along the direction of rotation D_{R} from the unbalanced position P_{unb}, the operator is capable of adjusting the balance of the rotating body 16.

In the case that the movement axis of the moving body 20 is the Y-axis, the second acquisition unit 48 acquires the positional deviation PD in the Y-axis direction. In this case, the second storage control unit 50B associates the compensated plurality of angles of rotation RA with the plurality of positional deviations PD in the Y-axis direction.

### (Exemplary Modification 8)

In relation to the Exemplary Modification 7, the machine tool 14 may be equipped with a moving body 20 that moves in the direction of the X-axis, and another moving body 20 that moves in the direction of the Y-axis. By the plurality of moving bodies 20 that move in different directions being connected to the main shaft portion 16A, it becomes possible for the rotating body 16 to move in a plurality of directions. In that case, the machine tool 14 is provided with a plurality of feeding motors 24 that enable the plurality of moving bodies 20 to move.

In the case that the machine tool 14 is equipped with the plurality of moving bodies 20 that move along directions of the movement axes that differ from each other, the second acquisition unit 48 acquires the positional deviation PD of either one of the plurality of directions of the movement axes. In this instance, the operator or the second acquisition unit 48 may select the direction of the movement axis for which the positional deviation PD is acquired. In this case, the second storage control unit 50B associates the compensated plurality of angles of rotation RA with the plurality of positional deviations PD in the direction of the movement axis that has been selected.

### (Exemplary Modification 9)

The display control unit 54 may output a graph showing the observation result, to an external device of the observation device 12. In other words, the display unit 34 that displays the graph may be installed externally of the observation device 12. For example, the display unit 34 may be a display device provided by the machine tool 14.

### (Exemplary Modification 10)

The observation device 12 may be integrally configured together with the control device 26 of the machine tool 14. In accordance with this feature, the observation device 12 is provided that also functions as the control device 26 of the machine tool 14.

### (Exemplary Modification 11)

The moving body 20 may be a member that moves relatively to the rotating body 16. In this case, the machine tool 14, for example, is a machining center. A tool is attached to the main shaft portion 16A of the machining center via a tool holder. The machining center, using a tool attached to the main shaft portion 16A, implements a cutting machining process on the workpiece. The workpiece is supported on a table that moves relatively to a main shaft (spindle) 18A. In this case, the rotating portion 16B is the tool holder, or alternatively, the tool itself. Further, the moving body 20 in this case is the table.

### (Exemplary Modification 12)

A case may exist in which the shaft 22a of the main shaft motor 22 is at the same position as the central line of rotation L_{C} of the rotating portion 16B on an X-Y plane. In this case, the first detector 18 may output a signal in accordance with the rotation of the shaft 22a. In this case, the observation device 12 may acquire the angle of rotation of the shaft 22a as the angle of rotation RA of the rotating portion 16B. Further, in this case, for example, a rotary encoder provided on the main shaft motor 22 can be used as the first detector 18.

### (Exemplary Modification 13)

The weight attachment and detachment portions 30 may be provided on the main shaft portion 16A. In this case, the balance correcting operation of the rotating body 16 is performed by carrying out attachment and detachment of the weight 28 with respect to the weight attachment and detachment portions 30 of the main shaft portion 16A.

### (Exemplary Modification 14)

The weight 28 may be an adhesive member that is adhered to the rotating body 16. The adhesive member, for example, is an adhesive tape. The balance state of the rotating body 16 is changed even by adhering the adhesive tape. By using the adhesive tape, the operator can easily perform fine adjustment on the balance state of the rotating body 16. Further, from the operator's point of view, the operation of adhering the adhesive tape to the rotating body 16 is easier than the operation of inserting the screws.

The adhesive member is adhered to the rotating body 16. Accordingly, it is not necessary for the weight attachment and detachment portions 30 to be holes. That is, for example, in the case that the balance state of the rotating body 16 is adjusted using the adhesive member, the screw holes described in the embodiment are unnecessary. In this case, each of the plurality of weight attachment and detachment portions 30 is a portion of the rotating body 16 to which the adhesive member is capable of being adhered.

### (Exemplary Modification 15)

According to the present embodiment, the moving body 20 is made to move along the movement axis using the ball screw and the feeding motor 24. Alternatively, the moving body 20 may also be moved in response to a linear force along the movement axis generated, for example, by a linear motor or a fluid bearing.

In the case that the moving body 20 is made to move using a linear motor or a fluid bearing, in order to calculate the positional deviation PD, it is necessary to measure the amount of movement of the moving body 20 in the direction of the movement axis. The amount of movement of the moving body 20 in the direction of the movement axis can be measured, for example, by using a scale.

The machine tool 14 which is equipped with the linear motor or the fluid bearing as an element for causing the moving body 20 to move, for example, is an ultra-high-precision machine tool. Such an ultra-high-precision machine tool is a machine tool 14 that carries out machining according to commands. A machining accuracy with which such an ultra-high-precision machine tool performs machining according to the commands is, for example, less than or equal to 10 nanometers.

### (Exemplary Modification 16)

The above-described embodiments and the respective modifications thereof may be appropriately combined within a range in which no technical inconsistencies occur.

[Inventions that can be Obtained from the Embodiment]

The inventions that can be grasped from the above-described embodiment and the modifications thereof will be described below.

### <First Invention>

The observation device (12) is configured to observe the balance state of the rotating body (16) of the machine tool (14), the machine tool including the rotating body, the detector (18) configured to detect the angle of rotation (RA) of the rotating body, and the moving body (20) configured to move along the movement axis perpendicular to the central line of rotation (L_{C}) of the rotating body. The observation device includes: the command output unit (44) configured to issue a command to the machine tool so as to stop the moving body at the predetermined position while the rotating body is made to rotate; the first acquisition unit (46) configured to acquire the angle of rotation, based on the detection signal of the detector; the first storage control unit (50A) configured to cause the storage unit (38) to store the angular difference (AD), in the direction of rotation (D_{R}) of the rotating body, between the installation position (Pₚᵣₑ) that is predetermined as the position at which the detector is to be installed and the installation position (P₁₈) at which the detector is actually installed; the second acquisition unit (48) configured to acquire the positional deviation (PD) of the moving body in the direction of the movement axis; the compensation unit (52) configured to compensate the plurality of angles of rotation based on the angular difference; the second storage control unit (50B) configured to cause the storage unit to store the plurality of compensated angles of rotation and the positional deviation corresponding to each of the plurality of compensated angles of rotation, in association with each other; and the display control unit (54) configured to cause the display unit (34) to display the graph showing the corresponding relationship between the plurality of compensated angles of rotation and the positional deviations that are stored in association with the plurality of compensated angles of rotation.

In accordance with such features, the observation device is provided which is capable of observing the balance state of the rotating body of the machine tool, without using the field balancer, and further, which facilitates the balance correcting operation of the rotating body.

The installation position may be a position on a line (L_{X}) that passes through the central line of rotation and that is parallel to the movement axis. In accordance with this feature, at the time when the positional deviation has become maximum in the first direction or the second direction, the installation position coincides with the unbalanced position of the rotating body, in the direction of rotation. The operator can easily perform an effective balance correcting operation.

The moving body may be capable of moving along the movement axis in the first direction (+X) and in the second direction (−X) opposite to the first direction, the observation device may be further equipped with the third storage control unit (50C) that causes the storage unit to store the polarity concerning the first direction and the second direction, and the display control unit may display the positional deviations with a polarity in accordance with the polarity stored in the storage unit. In accordance with such features, insofar as the same observation device is used, even if the observation is carried out on a plurality of machine tools the polarities of which are different, the operator can refer to the observation results with a unified polarity.

The observation device may be further equipped with the operation unit (36) that receives the operation of specifying the polarity, wherein the third storage control unit may cause the specified polarity to be stored in the storage unit. In accordance with this feature, the operator is capable of determining the polarity of the observation device, as desired.

The moving body may be capable of moving along the movement axis in the first direction (+X), and in the second direction (−X) opposite to the first direction, in the graph, the positional deviation that occurs in the first direction may be displayed with a positive polarity, and the positional deviation that occurs in the second direction may be displayed with a negative polarity, and the observation device may be further equipped with the fourth storage control unit (50D) that stores in the storage unit the orientation concerning the magnitude, of the axis indicating the magnitude of the positional deviation on the graph, and the display control unit may determine the region of the positive polarity and the region of the negative polarity on the graph, in accordance with the orientation concerning the magnitude stored in the storage unit. In accordance with such features, irrespective of the manner in which the polarity of the machine tool is set, the polarity of the direction indicating the positive polarity in the observation device is placed on a determined one side on the axis of the graph. At the same time, the polarity of the direction indicating the direction of the negative polarity in the observation device is placed on a determined other side on the axis of the graph.

The observation device may be further equipped with the operation unit (36) that receives the operation of specifying the orientation concerning the magnitude, wherein the fourth storage control unit may cause the specified orientation concerning the magnitude to be stored in the storage unit. In accordance with this feature, the operator is capable of determining the orientation concerning the magnitude, as desired.

The graph may include the angular axis (A_{RA}) representing, on the circle, the magnitude of the angle of rotation in the case that the positional deviation is zero, and the deviation axis (A_{PD}) representing the magnitude of the positional deviation, on the normal line to the circle. With this configuration, the balance state of the rotating body (16) at each angle of rotation can be represented.

The display control unit may cause the display unit to display the graph, together with further displaying the current angle of rotation of the rotating body on the graph. In accordance with this feature, the convenience of the operator who performs the balance correcting operation is achieved.

### <Second Invention>

The observation method for observing the balance state of the rotating body (16) of the machine tool (14) is provided, the machine tool including the rotating body, the detector (18) configured to detect the angle of rotation (RA) of the rotating body, and the moving body (20) configured to move along the movement axis perpendicular to the central line of rotation (L_{C}) of the rotating body. The observation method includes: the command output step (S1) of issuing the command to the machine tool so as to stop the moving body at the predetermined position while the rotating body is made to rotate; the first acquisition step (S3) of acquiring the angle of rotation, based on the detection signal of the detector; the first storage step (S2) of storing the angular difference (AD), in the direction of rotation (D_{R}) of the rotating body, between the installation position (Pₚᵣₑ) that is predetermined as the position at which the detector is to be installed and the installation position (P₁₈) at which the detector is actually installed; the second acquisition step (S4) of acquiring the positional deviation (PD) of the moving body in the direction of the movement axis; the compensation step (S5) of compensating the angle of rotation based on the angular difference, the angle of rotation comprising the plurality of angles of rotation; the second storage step (S6) of storing the plurality of angles of rotation after compensation as the plurality of compensated angles of rotation, and the positional deviation as positional deviations respectively corresponding to the plurality of compensated angles of rotation, in association with each other; and the display control step (S7) of causing the display unit (34) to display the graph showing the corresponding relationship between the plurality of compensated angles of rotation and the positional deviations that are stored in association with the plurality of compensated angles of rotation.

In accordance with such features, the observation method is provided which is capable of observing the balance state of the rotating body of the machine tool, without using the field balancer, and further, which facilitates the balance correcting operation of the rotating body.

The installation position may be on a line (L_{X}) that passes through the central line of rotation and that is parallel to the movement axis. In accordance with this feature, at the time when the positional deviation has become maximum in the first direction or the second direction, the installation position coincides with the unbalanced position of the rotating body, in the direction of rotation. The operator can easily perform an effective balance correcting operation.

The moving body may be capable of moving along the movement axis in the first direction (+X), and the second direction (−X) opposite to the first direction, the observation method may further include the third storage step of storing the polarity concerning the first direction and the second direction, and in the display control step, the positional deviations may be displayed with a polarity in accordance with the polarity stored in the third storage step. In accordance with such features, insofar as the same observation device is used, even if the observation is carried out on a plurality of machine tools the polarities of which are different, the operator can refer to the observation results with a unified polarity.

The second invention may further include the operation step of receiving the operation specifying the polarity, wherein, in the third storage step, the specified polarity may be stored. In accordance with this feature, the operator is capable of determining the polarity of the observation device, as desired.

The moving body may be capable of moving along the movement axis in the first direction (+X), and in the second direction (−X) opposite to the first direction, in the graph, the positional deviation that occurs in the first direction may be displayed with a positive polarity, and the positional deviation that occurs in the second direction may be displayed with a negative polarity, and the observation method may further include the fourth storage step of storing an orientation concerning the magnitude of the axis indicating the magnitude of the positional deviation on the graph, and in the display control step, there may be determined the region of the positive polarity and the region of the negative polarity on the graph, in accordance with the orientation concerning the magnitude stored in the fourth storage step. In accordance with such features, irrespective of the manner in which the polarity of the machine tool is set, the polarity of the direction indicating the positive polarity in the observation device is placed on a determined one side on the axis of the graph. At the same time, the polarity of the direction indicating the direction of the negative polarity in the observation device is placed on a determined other side on the axis of the graph.

The second invention may further include the operation step of receiving the operation of specifying the orientation concerning the magnitude, wherein, in the fourth storage step, the specified orientation concerning the magnitude may be stored. In accordance with this feature, the operator is capable of determining the orientation concerning the magnitude, as desired.

The graph may include the angular axis representing, on the circle, the magnitude of the angle of rotation in the case that the positional deviation is zero, and the deviation axis representing the magnitude of the positional deviation, on the normal line to the circle. With this configuration, the balance state of the rotating body at each angle of rotation can be represented.

In the display control step, the display unit may be caused to display the graph, and the current angle of rotation of the rotating body may be further displayed on the graph. In accordance with this feature, the convenience of the operator who performs the balance correcting operation is achieved.

1. An observation device configured to observe a balance state of a rotating body of a machine tool, the machine tool including the rotating body, a detector configured to detect an angle of rotation of the rotating body, and a moving body configured to move along a movement axis perpendicular to a central line of rotation of the rotating body, the observation device comprising:
a command output unit configured to issue a command to the machine tool so as to stop the moving body at a predetermined position while the rotating body is made to rotate;
a first acquisition unit configured to acquire the angle of rotation, based on a detection signal of the detector;
a first storage control unit configured to cause a storage unit to store an angular difference, in a direction of rotation of the rotating body, between an installation position that is predetermined as a position at which the detector is to be installed and an installation position at which the detector is actually installed;
a second acquisition unit configured to acquire a positional deviation of the moving body in a direction of the movement axis;
a compensation unit configured to compensate the angle of rotation based on the angular difference, the angle of rotation comprising a plurality of angles of rotation;
a second storage control unit configured to cause the storage unit to store the plurality of angles of rotation after compensation as a plurality of compensated angles of rotation, and the positional deviation as positional deviations respectively corresponding to the plurality of compensated angles of rotation, in association with each other; and
a display control unit configured to cause a display unit to display a graph showing a corresponding relationship between the plurality of compensated angles of rotation and the positional deviations that are stored in association with the plurality of compensated angles of rotation.

2. The observation device according to claim 1, wherein
the installation position is a position on a line that passes through the central line of rotation and that is parallel to the movement axis.

3. The observation device according to claim 1, wherein
the moving body is movable along the movement axis in a first direction, and in a second direction opposite to the first direction;
the observation device further comprises a third storage control unit configured to cause the storage unit to store a polarity concerning the first direction and the second direction; and
the display control unit displays the positional deviations with a polarity in accordance with the polarity stored in the storage unit.

4. The observation device according to claim 3, further comprising:
an operation unit configured to receive an operation specifying the polarity,
wherein the third storage control unit causes the polarity that has been specified, to be stored in the storage unit.

5. The observation device according to claim 1, wherein
the moving body is movable along the movement axis in a first direction, and in a second direction opposite to the first direction;
in the graph, the positional deviation that occurs in the first direction is displayed with a positive polarity, and the positional deviation that occurs in the second direction is displayed with a negative polarity, and
the observation device further comprises a fourth storage control unit configured to cause the storage unit to store a magnitude-related orientation of an axis indicating a magnitude of the positional deviation on the graph, and
the display control unit is configured to determine a region of the positive polarity and a region of the negative polarity on the graph, in accordance with the magnitude-related orientation stored in the storage unit.

6. The observation device according to claim 5, further comprising:
an operation unit configured to receive an operation specifying the magnitude-related orientation,
wherein the fourth storage control unit causes the magnitude-related orientation that has been specified, to be stored in the storage unit.

7. The observation device according to claim 1, wherein
the display control unit causes the display unit to display the graph with a current angle of rotation of the rotating body displayed on the graph.

8. An observation method for observing a balance state of a rotating body of a machine tool, the machine tool including the rotating body, a detector configured to detect an angle of rotation of the rotating body, and a moving body configured to move along a movement axis perpendicular to a central line of rotation of the rotating body, the observation method comprising:
a command output step of issuing a command to the machine tool so as to stop the moving body at a predetermined position while the rotating body is made to rotate;
a first acquisition step of acquiring the angle of rotation, based on a detection signal of the detector;
a first storage step of storing an angular difference, in a direction of rotation of the rotating body, between an installation position that is predetermined as a position at which the detector is to be installed and an installation position at which the detector is actually installed;
a second acquisition step of acquiring a positional deviation of the moving body in a direction of the movement axis;
a compensation step of compensating the angle of rotation based on the angular difference, the angle of rotation comprises a plurality of angles of rotation;
a second storage step of storing the plurality of angles of rotation after compensation as a plurality of compensated angles of rotation, and the positional deviation as positional deviations respectively corresponding to the plurality of compensated angles of rotation, in association with each other; and
a display control step of causing a display unit to display a graph showing a corresponding relationship between the plurality of compensated angles of rotation and the positional deviations that are stored in association with the plurality of compensated angles of rotation.

9. The observation method according to claim 8, wherein
the installation position is on a line that passes through the central line of rotation and that is parallel to the movement axis.

10. The observation method according to claim 8, wherein
the moving body is movable along the movement axis in a first direction, and in a second direction opposite to the first direction;
the observation method further comprises a third storage step of storing a polarity concerning the first direction and the second direction; and
in the display control step, the positional deviations are displayed with a polarity in accordance with the polarity stored in the third storage step.

11. The observation method according to claim 10, further comprising:
an operation step of receiving an operation specifying the polarity;
wherein, in the third storage step, the polarity that has been specified is stored.

12. The observation method according to claim 8, wherein
the moving body is movable along the movement axis in a first direction, and in a second direction opposite to the first direction;
in the graph, the positional deviation that occurs in the first direction is displayed with a positive polarity, and the positional deviation that occurs in the second direction is displayed with a negative polarity; and
the observation method further comprises a fourth storage step of storing a magnitude-related orientation of an axis indicating a magnitude of the positional deviation on the graph; and
in the display control step, there is determined a region of the positive polarity and a region of the negative polarity on the graph, in accordance with the magnitude-related orientation stored in the fourth storage step.

13. The observation method according to claim 12, further comprising:
an operation step of receiving an operation specifying the magnitude-related orientation;
wherein, in the fourth storage step, the magnitude-related orientation that has been specified is stored.

14. The observation method according to claim 8, wherein
in the display control step, the display unit is caused to display the graph, and a current angle of rotation of the rotating body is further displayed on the graph.
